(19) United States
(12) Patent Application Publication
(10) Pub. No.: US 2026/0258586 A1
(43) Pub. Date: Sep. 3, 2026

(54) PAPERMAKING MAT, WOUND BODY, AND METHOD FOR PRODUCING PAPER MAKING MAT

(71) Applicant: IBIDEN CO., LTD., Ogaki-shi (JP)

(72) Inventors: Wataru MATSUDA, Takahama-shi (JP); Tomohisa YAMAZAKI, Takahama-shi (JP); Toshiyuki MAEDA, Takahama-shi (JP)

(73) Assignee: IBIDEN CO., LTD., Ogaki-shi (JP)

(21) Appl. No.: 18/730,787

(22) PCT Filed: Feb. 22, 2024
(86) PCT No.: PCT/JP2024/006533

§ 371 Date: Jul. 22, 2024

(30) Foreign Application Priority Data
Apr. 3, 2023 (JP) 2023-060455
Sep. 8, 2023 (CN) 202311163478.1

(51) Int. Cl. D04H 1/732; B01D 53/94; D01G 9/00; D04H 1/4209; D04H 1/587; D04H 1/64

(52) U.S. Cl. CPC D04H 1/732; D01G 9/00; D04H 1/4209; D04H 1/587; D04H 1/64; B01D 53/94; D10B 2101/08; D10B 2505/00

(57) ABSTRACT

39 A papermaking mat that is less likely to be cracked even when being wound around a base material is provided. A papermaking mat of the present invention has a rectangular shape in a plan view and includes inorganic fibers, a first main surface, and a second main surface facing the first main surface. The first main surface includes multiple raised portions each having a linear shape. When the papermaking mat is viewed in a plan view, the raised portions: are aligned in one direction in a plane direction of the first main surface; have an average length of 5 to 200 mm, an average width of 1 to 50 mm, and an average height of 0.05 to 0.50 mm; amount to five or more in a range of a freely selected 10 cm-long×10 cm-wide square of the first main surface; and include a fiber bundle being formed by entangling multiple fibers and twisting together.

### TECHNICAL FIELD

The present invention relates to a papermaking mat, a wound body, and a method for producing a papermaking mat.

### BACKGROUND ART

Exhaust gas discharged from an internal combustion engine such as a diesel engine contains a particulate matter (hereinafter, also referred to as “PM”). Adverse effects of PM on the environment and human bodies have been problems. The exhaust gas also contains harmful gas components such as CO, HC, and NOx, causing concerns about effects of such harmful gas components on the environment and human bodies.

In view of the above, various exhaust gas conversion apparatuses that collect PM in exhaust gas and convert harmful gas components have been proposed. Such an exhaust gas conversion apparatus includes an exhaust gas treatment unit including porous ceramic such as silicon carbide or cordierite, a casing for housing the exhaust gas treatment unit, and a holding sealing material (mat material) between the exhaust gas treatment unit and the casing. The holding sealing material (mat material) is disposed mainly, for example, for preventing the exhaust gas treatment unit from being damaged by contact with the casing that covers the periphery of the exhaust gas treatment unit due to vibrations and impacts caused by operation of automobiles or the like, and for preventing exhaust gas leakage from a space between the exhaust gas treatment unit and the casing.

For increasing the force (surface pressure) of the mat material for holding the exhaust gas treatment unit, Patent Literature 1 discloses a mat material in which the surface pressure is improved by producing an alumina fiber aggregate using a specific spinning aid.

### CITATION LIST

### Patent Literature

Patent Literature 1: WO 2018/012423

### SUMMARY OF INVENTION

### Technical Problem

The mat material as described in Patent Literature 1 is wound around the exhaust gas treatment unit at the time of use.

However, this has such a problem that a difference between the inner and outer circumferences of the mat material during winding causes the mat material to be cracked.

The present invention has been made to solve the above problem, and an object of the present invention is to provide a papermaking mat that is less likely to be cracked even when being wound around a base material.

### Solution to Problem

That is, a papermaking mat of the present invention is a papermaking mat having a rectangular shape in a plan view and including: inorganic fibers; a first main surface; and a second main surface facing the first main surface, the first main surface including multiple raised portions each having a linear shape, and when the papermaking mat being viewed in a plan view, the multiple raised portions being aligned in one direction in a plane direction of the first main surface, having an average length of 5 to 200 mm, an average width of 1 to 50 mm, and an average height of 0.05 to 0.50 mm, amounting to five or more in a range of a freely selected 10 cm-long×10 cm-wide square of the first main surface, and including a fiber bundle being formed by entangling multiple fibers and twisting these fibers together.

In the papermaking mat of the present invention, the raised portions each having a predetermined shape are aligned in one direction at a predetermined density on the first main surface.

The papermaking mat of the present invention is used by being wound around a base material. At this time, the first main surface is positioned on the base material side, and the papermaking mat is wound in a direction perpendicular to the alignment direction of the raised portions.

The papermaking mat of the present invention is less likely to be cracked even when being wound around the base material in this manner.

This is considered to be due to the following reason.

The papermaking mat is produced by flowing a slurry containing inorganic fibers in a certain direction and scooping up the inorganic fibers.

When the slurry contains a fiber bundle entangled such that multiple inorganic fibers are concentrated and twisted, the fiber bundle is caught by other inorganic fibers.

Accordingly, the fiber bundles are likely to be aligned in a direction perpendicular to the flowing direction of the slurry.

Therefore, when a papermaking mat is produced using a slurry containing fiber bundles, the fiber bundles are aligned in one direction (i.e., in a direction perpendicular to the flowing direction of the slurry). In the papermaking mat produced in this manner, each of the fiber bundles positioned on or near a main surface of the papermaking mat forms a raised portion on the main surface of the papermaking mat. Thus, the raised portions are also aligned in one direction in the plane direction of the first main surface.

When inorganic fibers are scooped up while increasing and decreasing the amount of slurry to create a papermaking mat, raised portions are partially formed, and the raised portions are aligned in a direction perpendicular to the flowing direction of the slurry.

Conversely, the aligned raised portions in one direction on the first main surface as in the papermaking mat of the present invention means that the fiber bundles are aligned in one direction over the entire papermaking mat.

The fiber bundle and/or the raised portion have higher strength and are difficult to bend than a single inorganic fiber.

For this reason, the papermaking mat in which the fiber bundles and/or the raised portions are aligned in one direction is difficult to bend in the alignment direction of the fiber bundles and/or the raised portions but is easy to bend in the direction perpendicular to the alignment direction of the fiber bundles and/or the raised portions.

Thus, even when such a papermaking mat is bent in a direction perpendicular to the alignment direction of the fiber bundles and/or the raised portions (i.e., the alignment direction of the raised portions), stress is difficult to be generated, and cracking attributable to this stress is less likely to occur.

Therefore, the papermaking mat of the present invention is less likely to be cracked even when being wound around a base material.

In the papermaking mat of the present invention, the raised portions have an average length of 5 to 200 mm, an average width of 1 to 50 mm, and an average height of 0.05 to 0.50 mm.

Five or more of the raised portions are formed in a range of a freely selected 10 cm-long×10 cm-wide square of the first main surface.

When the shape and density of the raised portion are within the above ranges, the papermaking mat easily bends in a direction perpendicular to the alignment direction of the raised portions.

Therefore, the papermaking mat of the present invention can suitably exhibit an effect of being not cracked when being wound around a base material.

Preferably, the papermaking mat of the present invention contains an organic binder in an amount of 0.1 to 20 parts by weight and an inorganic binder in an amount of 0.1 to 10 parts by weight per 100 parts by weight of the inorganic fibers.

The organic binder and the inorganic binder bond the inorganic fibers to each other and maintain the shape of the papermaking mat.

When the amounts of the organic binder and the inorganic binder are in the above ranges, adhesion between the inorganic fibers is appropriate, and both flexibility and shape maintainability of the papermaking mat can be achieved.

In addition, falling off of the inorganic fibers from the papermaking mat and scattering of the inorganic fibers can be reduced or prevented.

In the papermaking mat of the present invention, preferably, the organic binder has a glass transition temperature Tg of 5° C. or less.

When the organic binder has a glass transition temperature Tg of 5° C. or less, an organic binder film formed of the organic binder has high strength, and a papermaking mat having high film elongation and excellent flexibility can be obtained.

In the papermaking mat of the present invention, preferably, the organic binder is at least one selected from the group consisting of: acrylic resins, acrylate latices, rubber latices, carboxymethyl cellulose and polyvinyl alcohol, all of which act as water-soluble organic polymers; styrene resins that act as a thermoplastic resin; and epoxy resins that act as a thermosetting resin.

In the papermaking mat of the present invention, preferably, the inorganic binder contains at least one selected from alumina, silica, silicon carbide, zirconia, boron nitride, diamond, and pumice.

These organic binders and inorganic binders are suitable for bonding the inorganic fibers to each other and maintaining the shape of the papermaking mat.

The papermaking mat of the present invention is preferably a papermaking mat produced through a fiber opening step of subjecting an inorganic fiber molded body to fiber opening in water and producing a slurry containing inorganic fibers that are opened, and a papermaking step of performing papermaking on the slurry to obtain a papermaking mat.

In fiber opening of the inorganic fiber molded body, there are cases where the inorganic fibers are not completely opened, resulting in fiber bundles of multiple fibers entangled and twisted together.

By intentionally generating such a fiber bundle, the raised portion can be formed on the first main surface of the papermaking mat.

The shape and density of the raised portion can be adjusted by adjusting the fiber opening conditions and the papermaking conditions.

In the papermaking mat of the present invention, preferably, the inorganic fiber molded body includes at least one of a first inorganic fiber molded body derived from a needle-punched mat or a second inorganic fiber molded body derived from a papermaking mat.

The fiber bundles can be formed in the fiber opening step regardless of whether the inorganic fiber molded body is derived from a needle-punched mat or a papermaking mat.

The papermaking mat of the present invention is preferably a papermaking mat obtained by performing papermaking by batchwise papermaking or continuous papermaking in the papermaking step.

Batchwise papermaking or continuous papermaking facilitates production of the papermaking mat of the present invention.

A wound body of the present invention including a base material, and a papermaking mat being wound around the base material, in which the papermaking mat is the papermaking mat of the present invention, and the papermaking mat includes the first main surface being located on a base material side and is wound in a direction perpendicular to an alignment direction of the multiple raised portions.

As described above, the papermaking mat of the present invention easily bends in a direction perpendicular to the alignment direction of the raised portions. In the wound body of the present invention, the papermaking mat of the present invention is wound in a direction perpendicular to the alignment direction of the raised portions.

Accordingly, in the wound body of the present invention, the papermaking mat is less likely to be cracked.

A method for producing a papermaking mat is a method for producing the papermaking mat of the present invention described above, and the method includes a fiber opening step of subjecting an inorganic fiber molded body to fiber opening in water and producing a slurry containing inorganic fibers that are opened, and a papermaking step of performing papermaking on the slurry to obtain a papermaking mat, in which, in the fiber opening step, the fiber opening includes forming a fiber bundle being formed by entangling the inorganic fibers and twisting these fibers together.

In fiber opening of the inorganic fiber molded body, there are cases where the inorganic fibers are not completely opened, resulting in fiber bundles of multiple fibers entangled and twisted together.

In the method for producing a papermaking mat of the present invention, a raised portion having a predetermined shape and a predetermined density can be formed on the first main surface of the papermaking mat by intentionally generating a fiber bundle.

The shape and density of the raised portion can be adjusted by adjusting the fiber opening conditions and the papermaking conditions.

In the method for producing a papermaking mat of the present invention, the inorganic fiber molded body preferably includes at least one of a first inorganic fiber molded body being derived from a needle-punched mat or a second inorganic fiber molded body being derived from a papermaking mat.

The fiber bundle can be formed in the fiber opening step regardless of whether the inorganic fiber molded body is derived from a needle-punched mat or a papermaking mat.

### Advantageous Effects of Invention

According to the present invention, a papermaking mat that is less likely to be cracked even when being wound around a base material can be provided.

### BRIEF DESCRIPTION OF DRAWINGS

FIG. 1A is a perspective view schematically showing an example of a papermaking mat of the present invention.

FIG. 1B is an enlarged view of a portion in FIG. 1A, encircled by a broken line.

FIG. 1C is a sectional view taken along line A-A in FIG. 1B.

FIG. 2A is a view schematically showing an example of a fiber opening step in a method for producing a papermaking mat of the present invention.

FIG. 2B is a schematic view of an example of a crimped fiber bundle.

FIG. 3 is a view schematically showing an example of a papermaking step in the method for producing a papermaking mat of the present invention.

FIG. 4 is a sectional view schematically showing an example of an exhaust gas conversion apparatus using the papermaking mat of the present invention.

FIG. 5 is a perspective view schematically showing an example of a wound body of the present invention.

FIG. 6A is a photograph of a test result of evaluation of winding properties using a papermaking mat according to Example 1.

FIG. 6B is a photograph of a test result of evaluation of winding properties using a papermaking mat according to Comparative Example 1.

### DESCRIPTION OF EMBODIMENTS

Hereinafter, the papermaking mat of the present invention is specifically described. The present disclosure is not limited to the features described below, and suitable modifications may be made without departing from the scope of the present invention. The present invention also encompasses a combination of two or more preferred features of the present invention described below.

A papermaking mat according to the present invention is described with reference to the drawings.

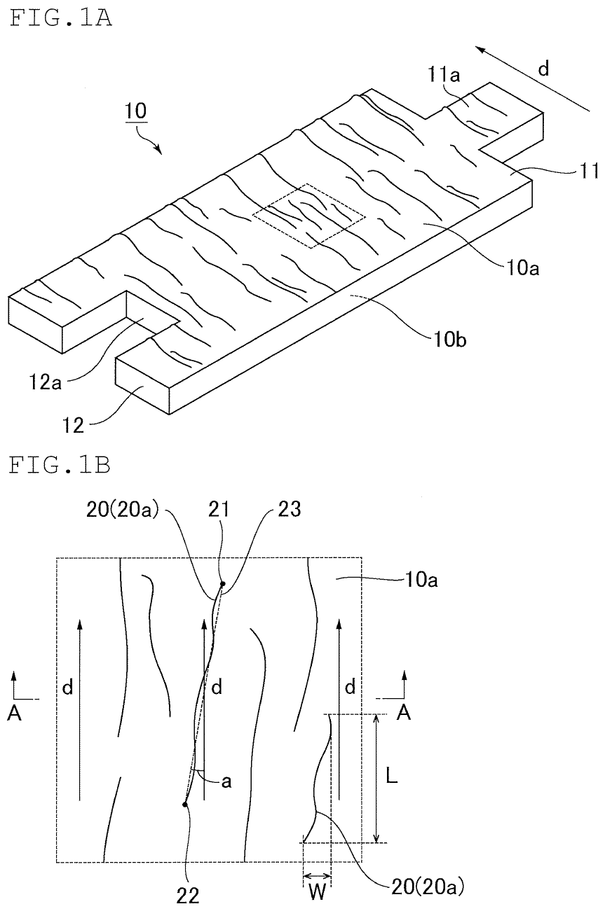

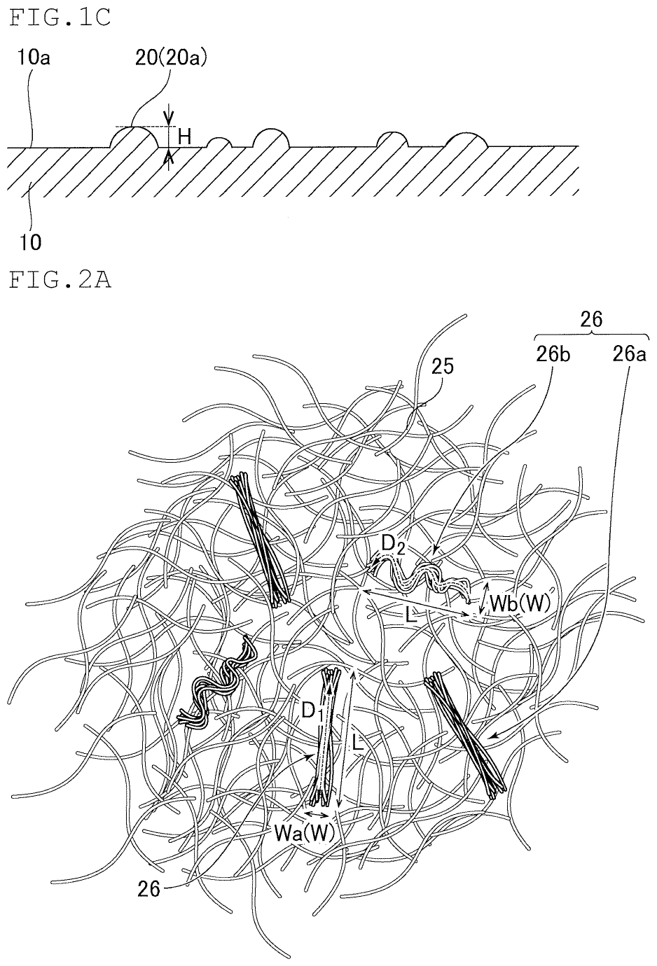

FIG. 1A is a perspective view schematically showing an example of the papermaking mat of the present invention.

FIG. 1B is an enlarged view of a portion in FIG. 1A, encircled by a broken line.

FIG. 1C is a sectional view taken along line A-A in FIG.

1B.

As shown in FIG. 1A, a papermaking mat 10 is a papermaking mat having a rectangular shape in a plan view, and including inorganic fibers, a first main surface 10a, and a second main surface 10b facing the first main surface 10a.

The papermaking mat 10 has a rectangular shape in a plan view, with a protrusion 11a at one end 11 and a recess 12a at another end 12.

The papermaking mat 10 is wound around an exhaust gas treatment unit and disposed in an exhaust gas conversion apparatus, which is described in detail later.

The protrusion 11a and the recess 12a have shapes that are exactly fitted to each other when the papermaking mat 10 is wound around the exhaust gas treatment unit.

The protrusion 11a and the recess 12a, when provided, improve sealing properties when the papermaking mat 10 is disposed in the exhaust gas conversion apparatus described later.

The papermaking mat of the present invention may not include either a protrusion or a recess at the ends.

As shown in FIGS. 1A and 1B, multiple linear raised portions 20 are formed on the first main surface 10a of the papermaking mat 10. Although not shown, multiple linear raised portions 20 are formed also on the second main surface 10b of the papermaking mat 10 similarly to the first main surface 10a.

When the papermaking mat 10 is viewed in a plan view, the raised portions 20 are aligned in one direction (a direction indicated by a reference sign d) in a plane direction of the first main surface. The alignment direction of the raised portions 20 is a direction perpendicular to the longitudinal direction of the papermaking mat 10.

Herein, whether “the raised portions are aligned in one direction” is determined by the following method.

First, as shown in FIG. 1B, a line segment 23 connecting one end 21 to the other end 22 of the raised portion 20 is drawn on the first main surface 10a of the papermaking mat 10. Next, the angle of an acute angle a formed by the line segment 23 and any direction d is measured. When the angle is 0° to 45°, the raised portion 20 from which the line segment 23 is derived is defined as a raised portion 20a aligned in the direction d.

When 50% or more off all the raised portions 20 are the raised portions 20a aligned in the direction d in a range of a freely selected 10 cm-long×10 cm-wide square of the first main surface 10a of the papermaking mat 10, the raised portions 20 are determined to be aligned in the direction d as a whole.

When the raised portion is in such a state, a determination is made that “the raised portions are aligned in one direction” in the papermaking mat.

The papermaking mat 10 is used by being wound around the exhaust gas treatment unit. At this time, the first main surface 10a is positioned on the exhaust gas treatment unit side, and the papermaking mat 10 is wound in a direction perpendicular to the alignment direction d of the raised portions 20.

The papermaking mat 10 is less likely to be cracked even when being wound around the exhaust gas treatment unit in this manner.

This is considered to be due to the following reason.

The papermaking mat 10 is produced by flowing a slurry containing inorganic fibers in a certain direction and scooping up the inorganic fibers.

When the slurry contains fiber bundles entangled such that multiple fibers are concentrated and twisted, the fiber bundles are caught by other inorganic fibers. Accordingly, the fiber bundles are likely to be aligned in a direction perpendicular to the flowing direction of the slurry.

Therefore, when the papermaking mat 10 is produced using a slurry containing fiber bundles, the fiber bundles are aligned in one direction (i.e., perpendicular to the flowing direction of the slurry). In the papermaking mat produced in this manner, the fiber bundles positioned on or near a main surface of the papermaking mat 10 forms the raised portions 20 on the main surface of the papermaking mat 10, and thus the raised portions 20 are also aligned in one direction.

The fiber bundle has higher strength and is more difficult to bend than a single inorganic fiber. For this reason, the papermaking mat 10 in which the fiber bundles are aligned in one direction is difficult to bend in the alignment direction of the fiber bundles but is easy to bend in the direction perpendicular to the alignment direction of the fiber bundles.

Thus, even when the papermaking mat 10 is bent in a direction perpendicular to the alignment direction of the fiber bundles (i.e., the alignment direction of the raised portions 20), stress is difficult to be generated, and cracking attributable to this stress is less likely to occur.

Therefore, the papermaking mat 10 is less likely to be cracked even when being wound around the exhaust gas treatment unit.

In the papermaking mat 10, the raised portions 20 have an average length (a distance denoted by a reference sign “L” in FIG. 1B) of 5 to 200 mm, an average width (a distance denoted by a reference sign “W” in FIG. 1) of 1 to 50 mm, and an average height (a height denoted by a reference sign “H” in FIG. 1C) of 0.05 to 0.50 mm.

In the papermaking mat 10, five or more raised portions 20 are formed in a range of a freely selected 10 cm-long×10 cm-wide square of the first main surface 10a.

When the shape and density of the raised portion 20 are within the above ranges, the papermaking mat 10 easily bends in a direction perpendicular to the alignment direction of the raised portions 20.

This is considered to be due to the following reason.

The shape and density of the raised portion 20 are related to the shape and density of the fiber bundle contained in the papermaking mat.

When the shape and density of the raised portion 20 are within the above ranges, the fiber bundle has the shape and density suitable for bending the papermaking mat 10 in a direction perpendicular to the alignment direction of the raised portions 20.

Therefore, the papermaking mat 10 can suitably exhibit an effect of being not cracked when being wound around the exhaust gas treatment unit.

The average length L of the raised portions 20 is preferably 5 to 200 mm, more preferably 50 to 150 mm.

The average width W of the raised portions 20 is preferably 1 to 50 mm, more preferably 5 to 50 mm.

The average height H of the raised portions 20 is preferably 0.05 to 0.50 mm, more preferably 0.1 to 0.3 mm.

The length L of the raised portion 20 means a distance from the one end 21 to the other end 22 of the raised portion 20 in the alignment direction d of the raised portion 20.

The width W of the raised portion 20 means the maximum width of the portion where the raised portion 20 is provided in the direction perpendicular to the alignment direction d of the raised portion 20.

The height H of the raised portion 20 means a distance from the first main surface 10a on which the raised portion 20 is not formed to the top of the raised portion 20.

In the papermaking mat 10, in a range of a freely selected 10 cm-long×10 cm-wide square of the first main surface 10a, five to twenty raised portions 20 are preferably formed, and seven to fifteen raised portions are more preferably formed.

The inorganic fibers constituting the papermaking mat 10 preferably include at least one selected from alumina fibers, silica fibers, alumina-silica fibers, mullite fibers, glass fibers, or bio-soluble fibers.

When the papermaking mat 10 includes these inorganic fibers, the papermaking mat 10 has a sufficient heat resistance.

The inorganic fibers constituting the papermaking mat 10 preferably have an average fiber diameter of 3 to 50 μm and an average fiber length of 100 to 100000 μm.

The bulk density of the papermaking mat 10 is preferably 0.05 to 0.30 g/cm³.

When the bulk density of the papermaking mat 10 is less than 0.05 g/cm³, the entanglement of the inorganic fibers is weak, and the inorganic fibers are easily separated from each other. Thus, the shape of the papermaking mat is difficult to be maintained in a predetermined shape.

When the bulk density of the papermaking mat 10 exceeds 0.30 g/cm³, the papermaking mat becomes hard, the winding properties are deteriorated, and tearing of the mat is likely to occur.

The papermaking mat 10 preferably contains the organic binder in an amount of preferably 0.1 to 20 parts by weight, more preferably 0.5 to 10 parts by weight, per 100 parts by weight of the inorganic fibers.

The papermaking mat 10 contains the inorganic binder in an amount of preferably 0.1 to 10 parts by weight, more preferably 0.5 to 3.0 parts by weight, per 100 parts by weight of the inorganic fibers.

The organic binder and the inorganic binder bond the inorganic fibers to each other and maintain the shape of the papermaking mat.

When the contents of the organic binder and the inorganic binder are within the above ranges, adhesion between the inorganic fibers is moderate, and both flexibility and shape maintainability of the papermaking mat can be provided.

Falling off of the inorganic fibers from the papermaking mat and scattering of the inorganic fibers can also be restrained.

In the papermaking mat 10, a glass transition temperature Tg of the organic binder is preferably 5° C. or lower, more preferably −35° C. to 5° C.

When the glass transition temperature Tg of the organic binder is 5° C. or lower, a papermaking mat having high film elongation and excellent flexibility can be obtained while increasing the strength of an organic binder film formed by the organic binder.

Tearing of the mat is less likely to occur in a situation such as winding of the papermaking mat 10 around the exhaust gas treatment unit. Since the organic binder film does not become too hard, the papermaking mat 10 exhibits an effect of keeping the inorganic fibers connected to each other at breakage of the inorganic fibers and can reduce or prevent the inorganic fibers from scattering.

An organic binder having the glass transition temperature Tg of less than −35° C. is expensive and increases production costs.

When the glass transition temperature Tg of the organic binder exceeds 5° C., the flexibility of the papermaking mat is lowered, and the breaking elongation may be lowered.

In the papermaking mat of the present invention, the organic binder may be a water-soluble organic polymer, a thermoplastic resin, or a thermosetting resin.

Examples of the water-soluble organic polymer include acrylic resins, acrylate latices, rubber latices, carboxymethyl cellulose, and polyvinyl alcohol. Examples of the thermoplastic resin include styrene resins. Examples of the thermosetting resin includes epoxy resins that act as the thermosetting resin.

In the papermaking mat 10, the inorganic binder preferably contains at least one selected from alumina, silica, silicon carbide, zirconia, boron nitride, diamond, and pumice.

These organic binders and inorganic binders are suitable for bonding the inorganic fibers to each other and maintaining the shape of the papermaking mat.

Next, the method for producing a papermaking mat of the present invention is described.

The method for producing a papermaking mat of the present invention includes (1) a fiber opening step and (2) a papermaking step.

In the following description, the case of using both a first inorganic fiber molded body derived from a needle-punched mat and a second inorganic fiber molded body derived from a papermaking mat as the inorganic fiber molded body is described. However, either one of the inorganic fiber molded bodies may be used in the method for producing a papermaking mat of the present invention.

Each step is described in detail below.

### (1) Fiber Opening Step

FIG. 2A is a view schematically showing an example of the fiber opening step in the method for producing a papermaking mat of the present invention.

In this step, the first inorganic fiber molded body derived from a needle-punched mat and the second inorganic fiber molded body derived from a papermaking mat are opened in water to produce a slurry containing the opened inorganic fibers. As shown in FIG. 2A, in fiber opening of a needle-punched mat and a papermaking mat, there are cases where inorganic fibers 25 are not be completely opened, resulting in a fiber bundle 26 of some inorganic fibers 25 entangled and twisted together.

More specific description is given as follows.

When producing a needle-punched mat, the inorganic fibers are entangled with each other with a needle, so that the inorganic fibers are highly entangled with each other at the needle-punched portion.

When producing a papermaking mat, the inorganic fibers are bonded to each other with an organic binder, so that the inorganic fibers are less likely to be separated from each other. When producing a papermaking mat by a papermaking method, unevenness occurs in aggregates of the inorganic fibers, forming a dense inorganic fiber aggregate.

The portion in which the inorganic fibers are entangled with each other with a needle in a needle-punched mat and the portion in which the inorganic fibers are aggregated at a high density in a papermaking mat are not easily opened and remain as fiber bundles formed from the inorganic fibers entangled and twisted together.

By intentionally forming the fiber bundle 26 described above, the raised portion can be formed on the main surface of the papermaking mat to be produced.

As shown in FIG. 2A, the fiber bundle 26 may include a straight fiber bundle (a bundle in a state denoted by a reference sign “26a” in FIG. 2A) or a crimped fiber bundle (a bundle in state denoted by a reference sign “26b” in FIG. 2A).

The expression “straight” as used herein refers to a state in which the fiber bundle extends linearly in the direction of the fiber bundle (the direction indicated by an arrow D1 in FIG. 2A).

The expression “crimped” as used herein refers to a state in which the fiber bundle is curved at least one in the direction of the fiber bundle (the direction indicated by an arrow D2 in FIG. 2A).

The average length of the fiber bundles 26 (an average value of lengths denoted by a reference sign L in FIG. 2A) is preferably 5 to 15 mm, more preferably 7 to 13 mm, still more preferably 8 to 10 mm.

The average width of the fiber bundles 26 (an average value of lengths denoted by a reference sign W in FIG. 2A) is preferably 0.2 to 1.0 mm, more preferably 0.2 to 0.8 mm.

As shown in FIG. 2A, when the fiber bundle 26 is a straight fiber bundle 26a, the maximum width (the length denoted by a reference sign Wa in FIG. 2A) is the width of the fiber bundle 26. Likewise, when the fiber bundle 26 is a crimped fiber bundle 26b, the maximum width (the length denoted by reference sign Wb in FIG. 2A) is the width of the fiber bundle 26.

The crimped fiber bundle 26b is described in detail below with reference to the drawings.

FIG. 2B is a schematic view of an example of a crimped fiber bundle.

In the crimped fiber bundle 26b shown in FIG. 2B, a trace length Lt of the crimped fiber bundle 26b measured by the following method for measuring a trace length is preferably greater than, more preferably 0.1 mm or more greater than, still more preferably 0.2 to 0.6 mm greater than the length L of the crimped fiber bundle 26b.

### Trace Length Measurement Method

The crimped fiber bundle 26b is placed still on a flat surface.

Next, the crimped fiber bundle 26b placed still is traced therealong from one end Pi to another end P2 of the crimped fiber bundle 26b viewed from above, and the traced distance It is defined as “the trace length of the crimped fiber bundle”.

When the trace length Lt of the crimped fiber bundle 26b is greater than the length L of the crimped fiber bundle 26b, the crimped fiber bundle 26b has a high elasticity, increasing the surface pressure of the papermaking mat 10.

Preferably, in the papermaking mat 10, the crimped fiber bundle 26b shown in FIG. 2B includes a crimped fiber bundle 26b in which a line segment S interconnecting the end Pi and the end P2 is crossed two or more times during tracing of the crimped fiber bundle 26b in measuring the “trace length of the crimped fiber bundle”.

The degree of crimp of this crimped fiber bundle 26b is suitable, the elasticity of the crimped fiber bundle 26b is increased, and the surface pressure of the papermaking mat 10 is improved.

The papermaking mat 10 preferably satisfies L^{t}/L=1.1 to 1.6, where L^{t}/L is the ratio of the trace length L^{t} of the crimped fiber bundle 26b to the length L of the crimped fiber bundle 26b.

In the papermaking mat 10, the value of the following Formula (1) is preferably 0.1 or more, more preferably 0.2 to 0.6.
(L^{t}−l)/Wb (1)

In the papermaking mat 10, the area of the crimped fiber bundle 26b is preferably 2.6 to 8.3 mm² when the crimped fiber bundle 26b is placed still on a flat surface and viewed from above.

In the papermaking mat 10, the percentage of the number of crimped fiber bundles 26b contained in the fiber bundles 26 is preferably 85% or less, more preferably 60% or less, still more preferably 30% or less, yet more preferably 10 to 30%.

In this step, dry-type fiber opening is preferably not performed.

This is because dry-type fiber opening may shorten the inorganic fibers to be opened and make a fiber bundle unable to be formed.

Examples of the fiber opening include the following methods.

First, the first inorganic fiber molded body and the second inorganic fiber molded body are baked at 700° C. to 1000° C. for 1.0 to 8.0 hours. A preferred baking temperature is 800° C. to 950° C.

In this way, the organic binder contained in the first inorganic fiber molded body and the second inorganic fiber molded body can be thermally decomposed, and the first inorganic fiber molded body and the second inorganic fiber molded body can be easily opened.

Next, the baked first inorganic fiber molded body and second inorganic fiber molded body are allowed to stand until the temperature falls to normal temperature, and then the first inorganic fiber molded body and the second inorganic fiber molded body are loosened by hand.

Next, the first inorganic fiber molded body and the second inorganic fiber molded body are put in water having an amount 50 to 400 times in weight ratio the amount of the first inorganic fiber molded body and the second inorganic fiber molded body, and the mixture is stirred to be subjected to fiber opening. With this step, a slurry containing inorganic fibers is produced. The amount of water is preferably 100 to 200 times in weight ratio the amount of the first inorganic fiber molded body and the second inorganic fiber molded body.

The condition of stirring is preferably set in an appropriate manner. For example, however, in the case of producing 10 L of slurry, stirring is preferably performed by using a stirrer (product name: SMT-101, manufacturer: AS ONE CORPORATION) at a rotation speed of 500 to 1000 rpm for a stirring time of 200 to 900 seconds. The conditions are preferably a rotation speed of 650 to 850 rpm and a stirring time of 500 to 700 seconds, more preferably a rotation speed of 700 to 800 rpm and a stirring time of 500 to 650 seconds.

Next, an organic binder and an inorganic binder are added to the slurry.

The organic binder is preferably added in an amount of 0.1 to 20 parts by weight, more preferably 0.5 to 15.0 parts by weight per 100 parts by weight of the inorganic fibers in the papermaking mat to be produced.

The inorganic binder is preferably added in an amount of 0.1 to 15.0 parts by weight, more preferably 0.5 to 10 parts by weight per 100 parts by weight of the inorganic fibers in the papermaking mat to be produced.

Since the types of preferred organic binders and inorganic binders have already been described, a description thereof is omitted.

### (2) Papermaking Step

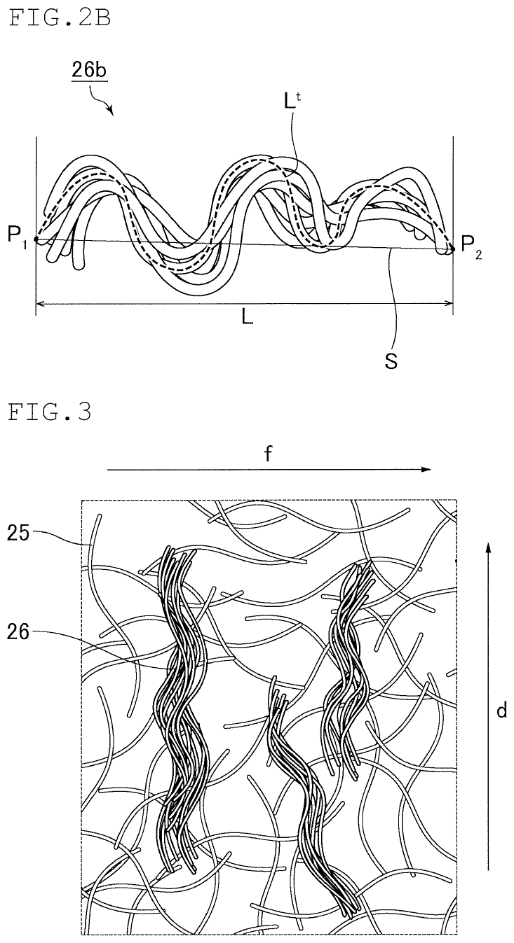

FIG. 3 is a view schematically showing an example of a papermaking step in the method for producing a papermaking mat of the present invention.

Next, the slurry is poured into a molder having a mesh for filtration formed on the bottom face, and the solvent in the slurry is removed to obtain an inorganic fiber aggregate.

As shown in FIG. 3, when the slurry is poured into the molder, the slurry containing the inorganic fibers 25 is flowed in a certain direction (direction indicated by an arrow f in FIG. 3).

The flow rate of the slurry is preferably 10 to 500 cm/min, more preferably 20 to 200 cm/min.

When the slurry contains the fiber bundles 26 entangled such that multiple inorganic fibers are concentrated and twisted, the fiber bundles 26 are caught by the other inorganic fibers 25. Accordingly, the fiber bundles 26 are likely to be aligned in a direction perpendicular to the flowing direction of the slurry (direction indicated by an arrow d in FIG. 3).

Therefore, when papermaking is performed using a slurry containing the fiber bundles 26, the fiber bundles 26 are aligned in the direction d. In the papermaking mat 10 obtained through the subsequent steps, the fiber bundle 26 positioned on or near the first main surface of the papermaking mat 10 forms the raised portion 20 on the first main surface of the papermaking mat 10. Thus, the raised portions 20 are also aligned in the direction d.

The alignment of the fiber bundles 26 can be adjusted by controlling factors including the content ratio of the inorganic fibers contained in the slurry, and the flow rate of the slurry.

Thereafter, the inorganic fiber aggregate is dehydrated, dried, and cut, whereby the papermaking mat 10 can be produced.

At this time, cutting is performed such that the longitudinal direction of the papermaking mat 10 is perpendicular to the alignment direction d of the raised portions 20.

In the thus produced papermaking mat 10, the fiber bundles 26 are aligned in the direction d over the entire papermaking mat 10.

The fiber bundle 26 has higher strength and is difficult to bend than a single one of the inorganic fiber 25. For this reason, the papermaking mat 10 in which the fiber bundles 26 are aligned in one direction is difficult to bend in the alignment direction d of the fiber bundles 26 but is easy to bend in the direction perpendicular to the alignment direction d of the fiber bundles 26.

Thus, even when this papermaking mat 10 is bent in a direction perpendicular to the alignment direction d of the fiber bundles 26, stress is difficult to be generated, and cracking attributable to this stress is less likely to occur.

Therefore, the papermaking mat 10 is less likely to be cracked even when being wound around the exhaust gas treatment unit.

In the papermaking step, the inorganic fiber aggregate may be dried by heating and pressurization. At the time of heating and pressurization, the inorganic fiber aggregate may be subjected to a heat treatment in which the inorganic fiber aggregate is dried by passing hot air therethrough. Alternatively, heating and pressurization may be started while the inorganic fiber aggregate remains in a wet state without being subjected to a heat treatment.

When heat treatment is performed, the heating temperature and the hot air temperature are preferably 100° C. to 250° C. in order to prevent deterioration of the organic binder due to heat.

In the range of 100° C. to 250° C., moisture can be evaporated from the inorganic fiber aggregate while deterioration of the organic binder is reduced or prevented. When the heating temperature or the hot air temperature is less than 100° C., the temperature is not transmitted to the central portion of the inorganic fiber aggregate, and the drying time increases. When the temperature exceeds 250° C., the organic binder is deteriorated, and the binding force between fibers is reduced.

Thus, the thickness of the inorganic fiber aggregate is difficult to be controlled.

In the method for producing a papermaking mat of the present invention, batchwise papermaking or continuous papermaking is preferably performed in the papermaking step.

Batchwise papermaking or continuous papermaking facilitates production of the papermaking mat of the present invention.

Next, the method of using a papermaking mat of the present invention is described.

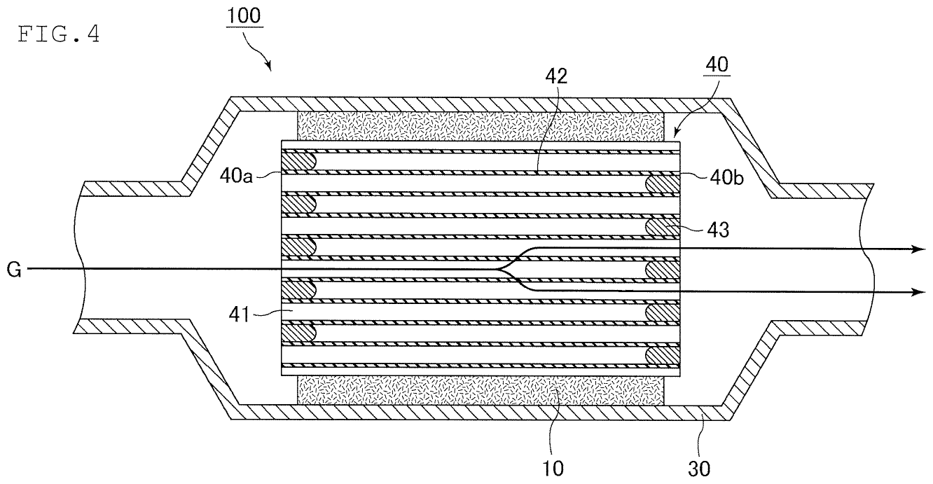

FIG. 4 is a sectional view schematically showing an example of an exhaust gas conversion apparatus using the papermaking mat of the present invention.

As shown in FIG. 4, an exhaust gas conversion apparatus 100 includes a metal casing 30, an exhaust gas treatment unit 40 housed in the metal casing 30, and the papermaking mat 10 between the exhaust gas treatment unit 40 and the metal casing 30. The papermaking mat 10 is the papermaking mat of the present invention.

The exhaust gas treatment unit 40 has a columnar shape in which a large number of cells 41 are arranged side by side in the longitudinal direction with cell walls 42 respectively separating the cells. An inlet tube for introducing the exhaust gas discharged from the internal combustion engine and an outlet tube for discharging the exhaust gas having passed through the exhaust gas conversion apparatus to the outside are connected to the respective ends of the metal casing 30, as necessary.

In the exhaust gas conversion apparatus 100 shown in FIG. 4, an exhaust gas filter (honeycomb filter) in which any one side of each cell is plugged by a plug 43 is used as the exhaust gas treatment unit 40. However, a catalyst support in which no ends are plugged by the plugs may be used.

As shown in FIG. 4, the exhaust gas discharged from the internal combustion engine and flowing into the exhaust gas conversion apparatus 100 (the exhaust gas is denoted by “G”, and the flow of the exhaust gas is indicated by an arrow in FIG. 4) flows into one of the cells 41 that is open to an exhaust gas inlet-side end 40a of the exhaust gas treatment unit (honeycomb filter) 40, and passes through the cell wall 42 separating the cells 41. At this time, PM in the exhaust gas is collected by the cell wall 42, and the exhaust gas is converted. The converted exhaust gas flows out from the other cell 41 that is open to an exhaust gas outlet-side end 40b, and is discharged to the outside.

The exhaust gas treatment unit 40 may include a porous non-oxide ceramic such as silicon carbide or silicon nitride, or may include a porous oxide ceramic such as SiAlON, alumina, cordierite, or mullite. Among them, silicon carbide is preferable.

When the exhaust gas treatment unit 40 is a silicon carbide porous ceramic, the porosity of the porous ceramic is not limited, but is preferably 35 to 60%.

When the porosity is less than 35%, the exhaust gas treatment unit may be quickly clogged. In contrast, when the porosity exceeds 60%, the strength of the exhaust gas treatment unit may be reduced, and the exhaust gas treatment unit may be easily broken.

The porous ceramic preferably has an average pore size of 5 to 30 μm.

When the average pore size is less than 5 μm, clogging with PM may easily occur.

When the average pore size exceeds 30 μm, the exhaust gas treatment unit may not function as a filter because PM passes through the pores and cannot be collected.

The porosity and the pore size can be measured by a conventionally known method for measurement using a scanning electron microscope (SEM).

The cell density in the section of the exhaust gas treatment unit 40 is not limited, but a preferred lower limit thereof is 31.0 pieces/cm² (200 pcs/inch² ), and the preferred upper limit thereof is 93.0 pcs/cm² (600 pcs/inch² ). A more preferred lower limit is 38.8 pieces/cm² (250 pcs/inch² ), and a more preferred upper limit is 77.5 pieces/cm² (500 pcs/inch² ).

The exhaust gas treatment unit 40 may support a catalyst for converting the exhaust gas. Examples of the preferred supported catalyst include noble metals such as platinum, palladium, and rhodium. Among them, platinum is more preferable. As another catalyst, for example, alkali metals such as potassium or sodium, or alkaline earth metals such as barium can also be used. These catalysts may be used alone or in combination of two or more thereof.

These catalysts, when supported, facilitate removal of PM by combustion, and toxic exhaust gas can also be converted.

### Metal Casing

The metal casing 30 has a substantially cylindrical shape.

Preferably, the inner diameter of the metal casing 30 (inner diameter of a portion for housing the exhaust gas treatment unit) is slightly smaller than a diameter of the exhaust gas treatment unit 40 around which the papermaking mat 10 is wound.

The metal casing 30 is not limited, but preferably includes stainless steel.

When this exhaust gas conversion apparatus 100 is produced, the papermaking mat 10 is wound around the exhaust gas treatment unit 40 to form a wound body and then is housed in the metal casing 30.

The wound body in which the papermaking mat 10 is wound around the exhaust gas treatment unit 40 is also the wound body of the present invention.

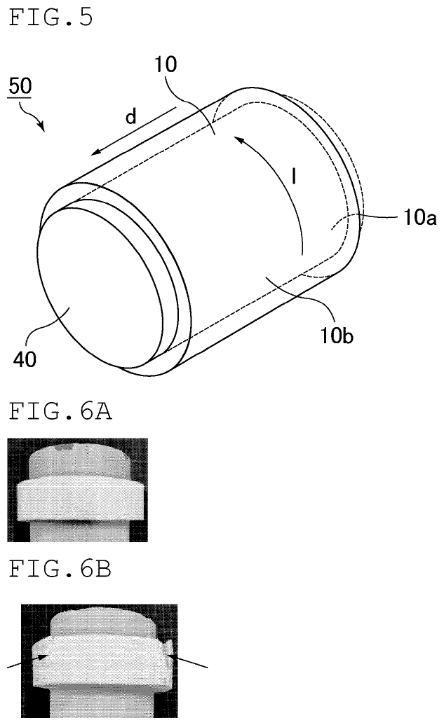

FIG. 5 is a perspective view schematically showing an example of the wound body of the present invention.

As shown in FIG. 5, a wound body 50 includes the exhaust gas treatment unit 40 as a base material and the papermaking mat 10 wound around the exhaust gas treatment unit 40.

In the wound body 50, the first main surface 10a of the papermaking mat 10 is positioned on the exhaust gas treatment unit 40 side, and the papermaking mat 10 is wound in a direction (a direction indicated by a reference sign “I” in FIG. 5) perpendicular to the alignment direction d of the raised portions (not shown).

As described above, the papermaking mat 10 easily bends in the direction I perpendicular to the alignment direction d of the raised portions, stress is difficult to be generated. In the wound body 50, since the papermaking mat 10 is wound in the direction I perpendicular to the alignment direction d of the raised portions, stress is difficult to be generated. Accordingly, also in the wound body 50, the papermaking mat 10 is less likely to be cracked.

In the above description, the wound body in which the papermaking mat is wound around the exhaust gas treatment unit has been described. However, in the wound body of the present invention, the base material around which the papermaking mat is wound is not limited to the exhaust gas treatment unit and may be a pipe or the like that requires heat retention.

The present specification discloses the following items.

The present disclosure (1) is a papermaking mat having a rectangular shape in a plan view, the papermaking mat including inorganic fibers, a first main surface, and a second main surface facing the first main surface, the first main surface including multiple raised portions each having a linear shape, and when the papermaking mat being viewed in a plan view, the multiple raised portions being aligned in one direction in a plane direction of the first main surface, having an average length of 5 to 200 mm, an average width of 1 to 50 mm, and an average height of 0.05 to 0.50 mm, amounting to five or more in a range of a freely selected 10 cm-long×10 cm-wide square of the first main surface, and including a fiber bundle being formed by entangling multiple fibers and twisting these fibers together.

The present disclosure (2) is the papermaking mat according to the present disclosure (1) further containing an organic binder in an amount of 0.1 to 20 parts by weight and an inorganic binder in an amount of 0.1 to 10 parts by weight per 100 parts by weight of the inorganic fibers.

The present disclosure (3) is the papermaking mat according to the present disclosure (2), in which Tg of the organic binder is 5° C. or less.

The present disclosure (4) is the papermaking mat according to the present disclosure (2) or (3), in which the organic binder is at least one selected from the group consisting of: acrylic resins, acrylate latices, rubber latices, carboxymethyl cellulose and polyvinyl alcohol, all of which act as a water-soluble organic polymer; styrene resins that act as a thermoplastic resin; and epoxy resins that act as a thermosetting resin.

The present disclosure (5) is the papermaking mat according to any one of the present disclosures (2) to (4), in which the inorganic binder contains at least one selected from alumina, silica, silicon carbide, zirconia, boron nitride, diamond, and pumice.

The present disclosure (6) is the papermaking mat according to any one of the present disclosures (1) to (5) that is produced through a fiber opening step of subjecting an inorganic fiber molded body to fiber opening in water and producing a slurry containing inorganic fibers that are opened, and a papermaking step of performing papermaking on the slurry to obtain a papermaking mat.

The present disclosure (7) is the papermaking mat according to the present disclosure (6), in which the inorganic fiber molded body includes at least one of a first inorganic fiber molded body being derived from a needle-punched mat or a second inorganic fiber molded body being derived from a papermaking mat.

The present disclosure (8) is the papermaking mat according to the present disclosure (6) or (7), in which, in the papermaking step, the papermaking is performed by batchwise papermaking or continuous papermaking.

The present disclosure (9) is a wound body including a base material, and a papermaking mat being wound around the base material, in which the papermaking mat is the papermaking mat according to any one of the present disclosures (1) to (8), and the papermaking mat includes the first main surface being located on the base material side and is wound in a direction perpendicular to an alignment direction of the multiple raised portions.

The present disclosure (10) is a method for producing the papermaking mat according to any one of the present disclosures (1) to (8), the method including a fiber opening step of subjecting an inorganic fiber molded body to fiber opening in water and producing a slurry containing inorganic fibers that are opened, and a papermaking step of performing papermaking on the slurry to obtain a papermaking mat, in which, in the fiber opening step, the fiber opening includes forming a fiber bundle being formed by entangling the inorganic fibers and twisting these fibers together.

The present disclosure (11) is the method according to the present disclosure (10), in which the inorganic fiber molded body includes at least one of a first inorganic fiber molded body being derived from a needle-punched mat or a second inorganic fiber molded body being derived from a papermaking mat.

### EXAMPLES

Hereinafter, examples more specifically disclosing the present invention is described. Note that the present invention is not limited only to these examples.

### Example 1

A first inorganic fiber molded body was prepared. The first inorganic fiber molded body was derived from a needle-punched mat including alumina-silica fibers that satisfied Al₂O₃:SiO₂=72:28 (weight ratio), and having a bulk density of 0.17 g/cm³ and a density of needle holes of 21 pieces/cm².

A second inorganic fiber molded body was also prepared. The second inorganic fiber molded body was derived from a papermaking mat including alumina-silica fibers that satisfied Al₂O₃:SiO₂=72:28 (weight ratio), and having a bulk density of 0.12g/cm³.

Next, the first inorganic fiber molded body and the second inorganic fiber molded body were baked at 600° C. for 1 hour to thermally decompose the organic binder contained in the first inorganic fiber molded body and the second inorganic fiber molded body.

Next, the baked first inorganic fiber molded body and second inorganic fiber molded body were allowed to stand until the temperature fell to normal temperature, and then the first inorganic fiber molded body and the second inorganic fiber molded body were loosened by hand.

Each of the first inorganic fiber molded body and the second inorganic fiber molded body was taken out in an amount of 5.0 g, and both were put in 0.4 L of water. Thereafter, the mixture was stirred using a stirrer (product name: SMT-101, manufacturer: AS ONE CORPORATION) at a rotation speed of 1000 rpm for a stirring time of 10 minutes to perform fiber opening, thereby producing a slurry of inorganic fibers.

In order to confirm whether fiber bundles were formed in the slurry, a part of the slurry was taken out and dried. As a result of confirmation, a fiber bundle in which multiple inorganic fibers were entangled and twisted together was formed.

Next, an organic binder was added to the slurry in an amount of 0.5 to 10 parts by weight per 100 parts by weight of the inorganic fibers.

An inorganic binder was also added to the slurry in an amount of 0.5 to 3.0 parts by weight per 100 parts by weight of the inorganic fibers.

Next, the slurry was poured into a molder having a mesh for filtration formed on the bottom face, and the solvent in the slurry was removed to obtain an inorganic fiber aggregate. At this time, the flow rate of the slurry was set to 10 to 100 cm/min.

Thereafter, the inorganic fiber aggregate was dehydrated and dried at 150° C. to 210° C. for 5 minutes to 1.0 hours to produce a papermaking mat according to Example 1. The thickness of the papermaking mat according to Example 1 was 13 mm.

When one main surface (i.e., the first main surface) of the papermaking mat according to Example 1 was observed, multiple linear raised portions were formed on the first main surface, and the raised portions were aligned in one direction.

The raised portions formed on the papermaking mat according to Example 1 had the average length L of 100 mm, the average width W of 30 mm, and the average height of 0.4 mm. When the number of raised portions formed was counted in the range of 10 cm-long×10 cm-wide square at six locations on the first main surface, the number thereof were 15, 14, 10, 8, 9, 5, and 10 in these regions.

### Comparative Example 1

A silica sol was blended to an aqueous solution of basic aluminum chloride in such a manner that the composition ratio of the baked inorganic fibers satisfies Al₂O₃:SiO₂=72:28 (weight ratio), and a proper amount of an organic polymer (polyvinyl alcohol) was added to prepare a mixed solution. The obtained mixed solution was concentrated to obtain a spinning mixture. The spinning mixture was spun by blowing (spinning atmosphere temperature: 120° C.) to produce an alumina fiber precursor.

Next, the obtained inorganic fiber precursor was compressed to produce a continuous sheet. Thereafter, the sheet was disposed in a heating furnace and subjected to baking treatment to produce an inorganic fiber aggregate.

Subsequently, the inorganic fiber aggregate was subjected to fiber opening by stirring using a stirrer (product name: SMT-101, manufacturer: AS ONE CORPORATION) at a rotation speed of 1000 rpm for a stirring time of 10 minutes.

In order to confirm whether fiber bundles were formed in the slurry, a part of the slurry was taken out and dried. As a result of confirmation, a fiber bundle in which multiple inorganic fibers were entangled and twisted together was not formed.

Next, an organic binder was added to the slurry in an amount of 0.5 to 10 parts by weight per 100 parts by weight of the inorganic fibers.

An inorganic binder was also added to the slurry in an amount of 0.5 to 3.0 parts by weight per 100 parts by weight of the inorganic fibers.

Next, the slurry was poured into a molder having a mesh for filtration formed on the bottom face, and the solvent in the slurry was removed to obtain an inorganic fiber aggregate. At this time, the flow rate of the slurry was set to 10 to 100 cm/min.

Thereafter, the inorganic fiber aggregate was dehydrated and dried at 150° C. to 210° C. for 5 minutes to 1.0 hours to produce a papermaking mat according to Comparative Example 1. The thickness of the papermaking mat according to Comparative Example 1 was 12.9 mm.

When the main surface of the papermaking mat according to Comparative Example 1 was observed, no raised portion was formed.

### Evaluation of Winding Properties

Each of the papermaking mats according to Example 1 and Comparative Example 1 was cut into a rectangle having a length of 350 mm in the longitudinal direction and a length of 30 mm in the transverse direction to produce a test piece.

At this time, cutting was performed so that the pouring direction of the slurry into the molder matched with the longitudinal direction of the test piece in the papermaking step in producing a papermaking mat.

In the test piece according to Example 1, the longitudinal direction matches with the direction perpendicular to the alignment direction d of the raised portions.

Next, a cylinder having a diameter of 100 mm was prepared, and each test piece was wound around the cylinder so that the longitudinal direction of each test piece matched with the winding direction. Then, whether each test piece was cracked was visually observed.

The results are shown in FIGS. 6A and 6B.

FIG. 6A is a photograph of a test result of evaluation of winding properties using the papermaking mat according to Example 1.

FIG. 6B is a photograph of a test result of evaluation of winding properties using the papermaking mat according to Comparative Example 1.

As shown in FIG. 6A, in the evaluation of winding properties using the papermaking mat according to Example 1, the test piece was not cracked.

In contrast, as shown in FIG. 6B, in the evaluation of winding properties using the papermaking mat according to Comparative Example 1, the test piece was cracked (cracks were indicated by arrows in FIG. 6B).

As found from these results, the papermaking mat according to Example 1 is less likely to be cracked even when being wound around a base material.

### REFERENCE SIGNS LIST

10 papermaking mat
10a first main surface
10b second main surface
11 one end
11a protrusion
12 another end
12a recess
20 raised portion
20a raised portion aligned in direction d
21 one end of raised portion
22 other end of raised portion
23 line segment
25 inorganic fiber
26 fiber bundle
26a crimped fiber bundle
26b crimped fiber bundle
30 metal casing
40 exhaust gas treatment unit
40a exhaust gas inlet-side end
40b exhaust gas outlet-side end
41 cell
42 cell wall
43 plug
50 wound body
100 exhaust gas conversion apparatus

1. A papermaking mat having a rectangular shape in a plan view, the papermaking mat comprising:
inorganic fibers;
a first main surface; and
a second main surface facing the first main surface,
the first main surface including multiple raised portions each having a linear shape,
when the papermaking mat being viewed in a plan view, the multiple raised portions being aligned in one direction in a plane direction of the first main surface, having an average length of 5 to 200 mm, an average width of 1 to 50 mm, and an average height of 0.05 to 0.50 mm, amounting to five or more in a range of a freely selected 10 cm-long×10 cm-wide square of the first main surface, and including a fiber bundle being formed by entangling multiple fibers and twisting these fibers together.

2. The papermaking mat according to claim 1,
wherein the papermaking mat contains an organic binder in an amount of 0.1 to 20 parts by weight and an inorganic binder in an amount of 0.1 to 10 parts by weight per 100 parts by weight of the inorganic fibers.

3. The papermaking mat according to claim 2, wherein Tg of the organic binder is 5° C. or less.

4. The papermaking mat according to claim 2, wherein
the organic binder is at least one selected from the group consisting of
acrylic resins, acrylate latices, rubber latices, carboxymethyl cellulose and polyvinyl alcohol, all of which act as a water-soluble organic polymer,
styrene resins that act as a thermoplastic resin, and
epoxy resins that act as a thermosetting resin.

5. The papermaking mat according to claim 2, wherein the inorganic binder comprises at least one selected from the group consisting of alumina, silica, silicon carbide, zirconia, boron nitride, diamond, and pumice.

6. A wound body comprising:
a base material; and
a papermaking mat being wound around the base material,
wherein the papermaking mat is the papermaking mat according to claim 1, and
the papermaking mat includes a first main surface being located on a base material side and is wound in a direction perpendicular to an alignment direction of multiple raised portions.

7. A method for producing the paper making mat according to claim 1, the method comprising:
a fiber opening step of subjecting an inorganic fiber molded body to fiber opening in water and producing a slurry containing inorganic fibers that are opened; and
a papermaking step of performing papermaking on the slurry to obtain a papermaking mat,
wherein, in the fiber opening step, the fiber opening includes forming a fiber bundle being formed by entangling the inorganic fibers and twisting these fibers together.

8. The method for producing the paper making mat according to claim 7, wherein
the inorganic fiber molded body includes at least one a first inorganic fiber molded body being derived from a needle-punched mat or a second inorganic fiber molded body being derived from a papermaking mat.

9. The papermaking mat according to claim 3, wherein
the organic binder is at least one selected from the group consisting of
acrylic resins, acrylate latices, rubber latices, carboxymethyl cellulose and polyvinyl alcohol, all of which act as a water-soluble organic polymer,
styrene resins that act as a thermoplastic resin, and
epoxy resins that act as a thermosetting resin.

10. The papermaking mat according to claim 3, wherein the inorganic binder comprises at least one selected from the group consisting of alumina, silica, silicon carbide, zirconia, boron nitride, diamond, and pumice.

11. The papermaking mat according to claim 4, wherein the inorganic binder comprises at least one selected from the group consisting of alumina, silica, silicon carbide, zirconia, boron nitride, diamond, and pumice.

12. A wound body comprising:
a base material; and
a papermaking mat being wound around the base material,
wherein the papermaking mat is the papermaking mat according to claim 2, and
the papermaking mat includes a first main surface being located on a base material side and is wound in a direction perpendicular to an alignment direction of multiple raised portions.

13. A wound body comprising:
a base material; and
a papermaking mat being wound around the base material,
wherein the papermaking mat is the papermaking mat according to claim 3, and the papermaking mat includes a first main surface being located on a base material side and is wound in a direction perpendicular to an alignment direction of multiple raised portions.

14. A wound body comprising:
a base material; and
a papermaking mat being wound around the base material,
wherein the papermaking mat is the papermaking mat according to claim 4, and the papermaking mat includes a first main surface being located on a base material side and is wound in a direction perpendicular to an alignment direction of multiple raised portions.

15. A wound body comprising:
a base material; and
a papermaking mat being wound around the base material,
wherein the papermaking mat is the papermaking mat according to claim 5, and the papermaking mat includes a first main surface being located on a base material side and is wound in a direction perpendicular to an alignment direction of multiple raised portions.

16. A method for producing the paper making mat according to claim 2, the method comprising:
a fiber opening step of subjecting an inorganic fiber molded body to fiber opening in water and producing a slurry containing inorganic fibers that are opened; and
a papermaking step of performing papermaking on the slurry to obtain a papermaking mat,
wherein, in the fiber opening step, the fiber opening includes forming a fiber bundle being formed by entangling the inorganic fibers and twisting these fibers together.

17. A method for producing the paper making mat according to claim 3, the method comprising:
a fiber opening step of subjecting an inorganic fiber molded body to fiber opening in water and producing a slurry containing inorganic fibers that are opened; and
a papermaking step of performing papermaking on the slurry to obtain a papermaking mat,
wherein, in the fiber opening step, the fiber opening includes forming a fiber bundle being formed by entangling the inorganic fibers and twisting these fibers together.

18. A method for producing the paper making mat according to claim 4, the method comprising:
a fiber opening step of subjecting an inorganic fiber molded body to fiber opening in water and producing a slurry containing inorganic fibers that are opened; and
a papermaking step of performing papermaking on the slurry to obtain a papermaking mat,
wherein, in the fiber opening step, the fiber opening includes forming a fiber bundle being formed by entangling the inorganic fibers and twisting these fibers together.

19. A method for producing the paper making mat according to claim 5, the method comprising:
a fiber opening step of subjecting an inorganic fiber molded body to fiber opening in water and producing a slurry containing inorganic fibers that are opened; and
a papermaking step of performing papermaking on the slurry to obtain a papermaking mat,
wherein, in the fiber opening step, the fiber opening includes forming a fiber bundle being formed by entangling the inorganic fibers and twisting these fibers together.
